(19) United States
(12) Patent Application Publication
(10) Pub. No.: US 2005/0144942 A1
(43) Pub. Date: Jul. 7, 2005

(54) Liquid nitrogen machine for cooling and electricity production

(76) Inventor: Nawaf Suleiman, Vienna (AT)

Correspondence Address: NAWAF SULEIMAN;c/o CATHY WAREHAM, 3341 BURRITT WAY, LA CRESCENTA, CA, 91214, US

(21) Appl. No.: 10/747,284

(22) Filed: Jan. 2, 2004

(51) Int. Cl. B60L 1/02

(52) U.S. Cl. 60/516

(57) ABSTRACT

A machine operated by liquid Nitrogen supplied form a container connected with it through a radiator (27). Liquid Nitrogen evaporates at −195 C and absorbs heat through radiator (27), the volume of gas expands and gas rushes into the movement box (1), starts replacing the liquid till it starts floating and moving up till it reaches the surface of the liquid, the cover (4) then opens letting all the gas out of it, and consequently moving down under the effect of its weight till it reaches the bottom and the cover closes tightly once again, the gas replaces water to move the box up, and so on. The vertical movement is transferred into a rotational movement operating the electrical generator, or producing electricity directly from the vertical movement by coiling an insulated copper coil surrounding its vertical path.

Electrical energy almost operates Cooling systems. The amount of electrical energy used in many hot countries for cooling machines is equivalent to 70% of the electrical energy produced from electrical stations.

As a result 70% of the energy used is being lost in the external environment; raising the temperature of the environment in order to cool a certain area for a limited periods.

Air and water have been storing solar energy for thousands of years, in the last century oil and flammable materials were used to produce energy, which was and still harmful to the environment. In addition to the hurt or detriment caused by coolant gases i.e. CFC. A thermal pump is used for producing heat and as per the experiment of Lord Calvin in which he proved that the quantity of heat being produced through the thermal pump condenser is equivalent to six times the energy produced by an electric heater. (M. Zemansky and other, pg. 151, 6th edition).

The energy in the form of heat which been transferred via the condenser is equivalent to five times the energy used to operate the compressor. The electrical energy is been stored in the gas as a potential energy when converting the gas into liquid. The heat which was lost from gas in addition to the heat converting from electrical energy operated the compressor, all together will be lost in the air. That means that the quantity of energy been absorbed by cooling is equal to approximately five times the electrical energy used for liquefaction of gas.

Energy can not be created or destroyed, but it can be transformed from one form into another, this invention is based on the electrical energy used to operate the machines for gas and air liquefaction, which is been distributed or wasted in the air. This energy can be re-substituted and reused using those gases to at least substitute the consumed energy by the ability of gas to absorb thermal energy and transform it to mechanical energy.

By flowing the gas into a higher temperature liquid, so that the energy (heat) will be transferred from the liquid to the gas, as a result the liquid become cold and the gas expand. At the same time the gas replaces the liquid inside an inverted tank. As the gas absorbs liquid's energy, its volume expands and replaces more water. It generates an uplifting force capable to push the tank to move upward. The tank moves upward and drives an electric generator by means of a wheel. As the tank reaches to the top, box cover is opened and the tank is allowed to sink under its weight, and so on.

The volume of gas inside the tank expands because as mentioned before it absorbs energy, when the volume of gas increases the uplifting force increases. If for example the volume of the inverted box is 9000 litre, and its weight is 4000 kg, under a ten meter depth under the water, provided that 10 litres of N2 were rushed to the inverted box, N2 will evaporate and expand to approximately 4400 litre, the temperature of N2 increases to 0 C, the inverted box starts its upward movement with uplifting force of 400 kg, this force increases as the box goes up because of the decrease of pressure, and also because of the decrease of moving matter and the continuous replacement of gas to the liquid. The heat transfer between gas and liquid is continuous till the box reaches the surface of the liquid; the volume of gas reaches approximately at the point 8810 litre.

By this it is obvious that the energy or heat transfers from the liquid to the gas which is directly converted into a mechanical work even in a −100 C if an antifreeze liquid was used, this machine produces cooling and electricity at once. And it is used also for cooling vapor condensers by absorbing its heat and converting it into electricity instead of using cooling towers, which consumes energy and water. It can be used for producing electricity as well as sweet water, and for agriculture by freezing salt water till ice get afloat on the surface.

For electricity production from solar energy absorbed by solar collectors connected to the liquid inside the container of the machine. It used also for electricity production by direct substitution of electricity used to operate air liquefaction units.

This invention contains:

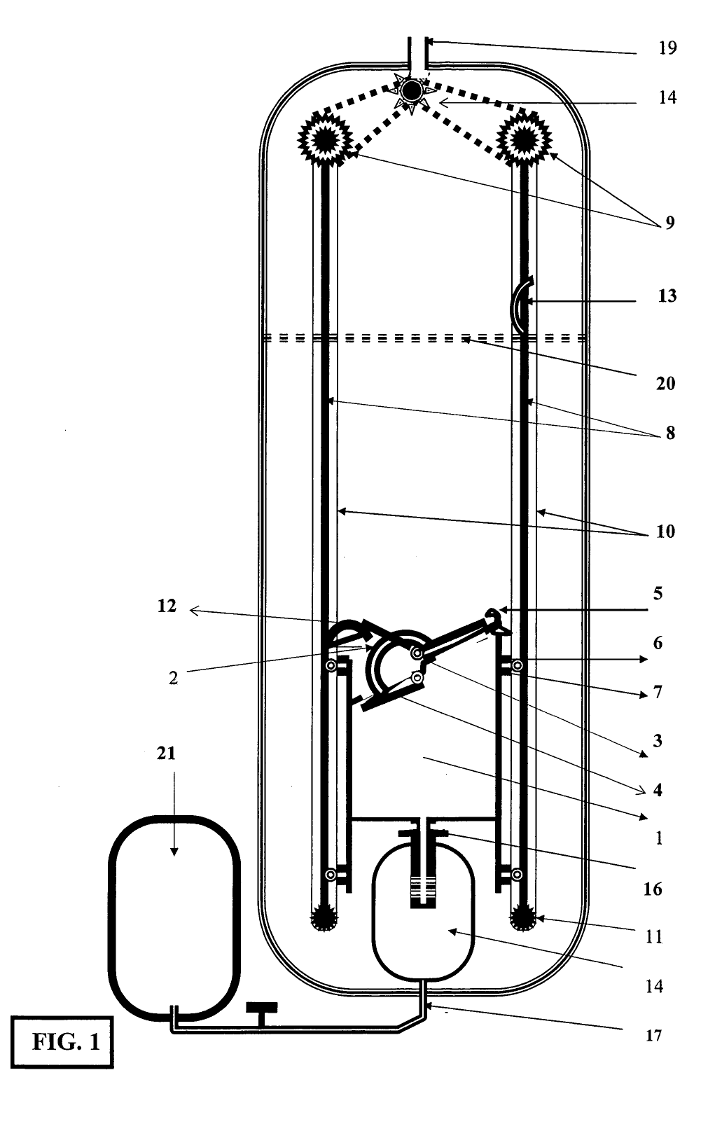

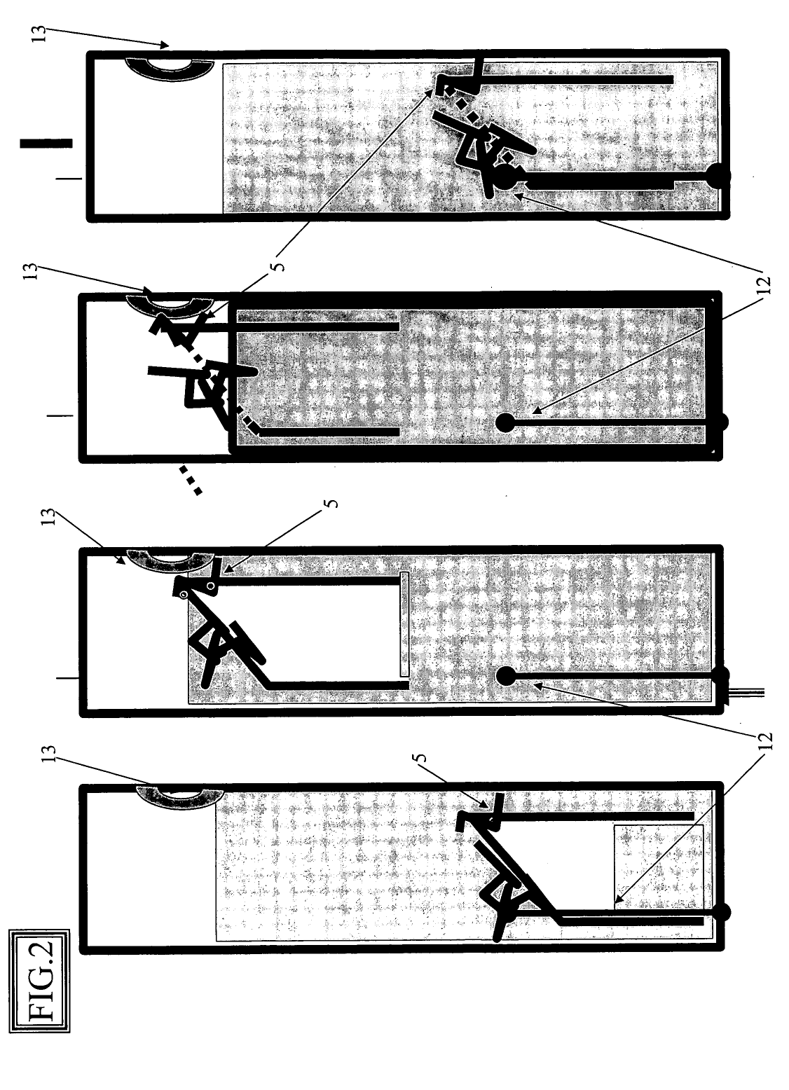

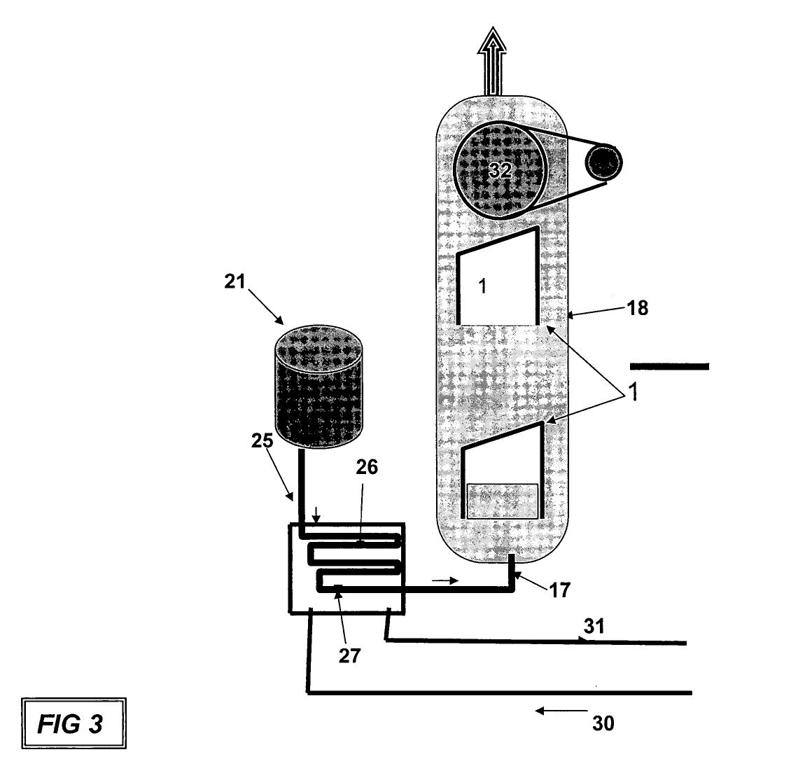

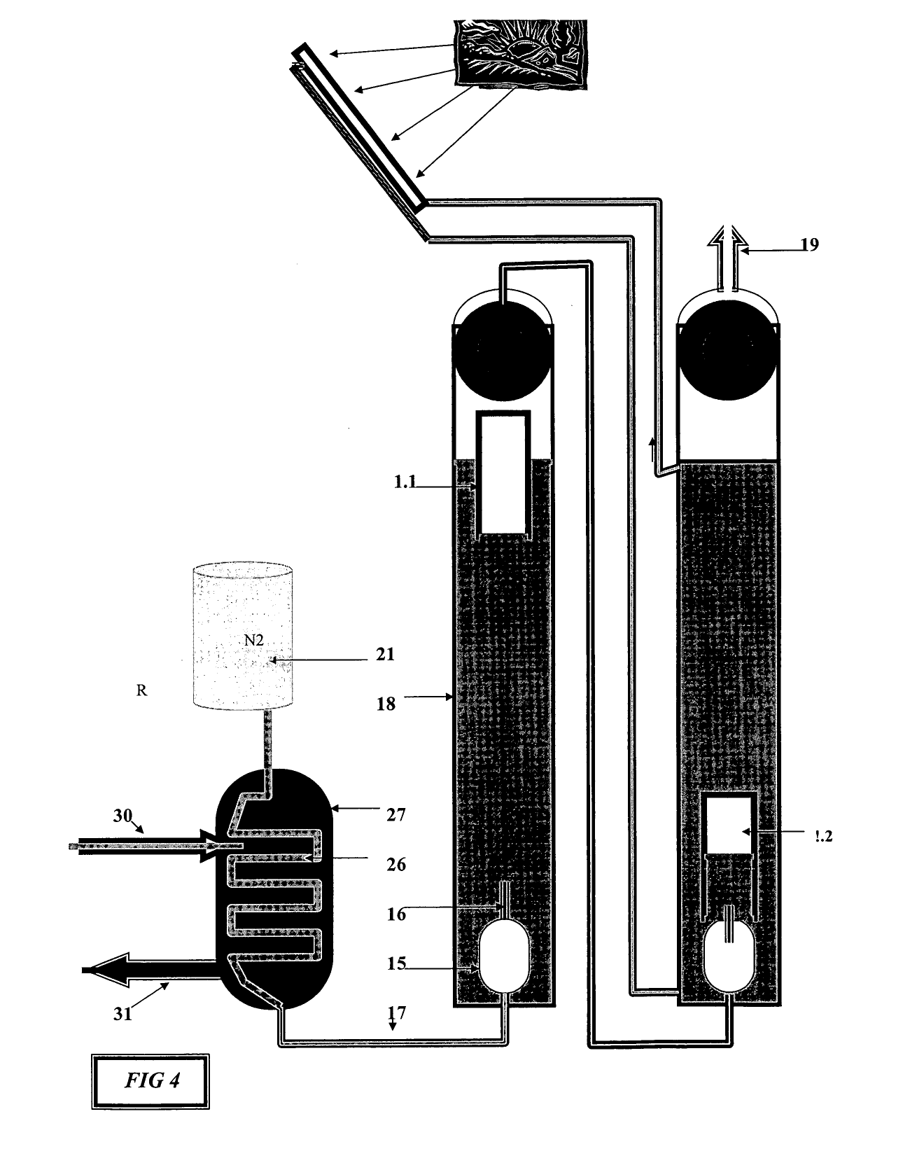

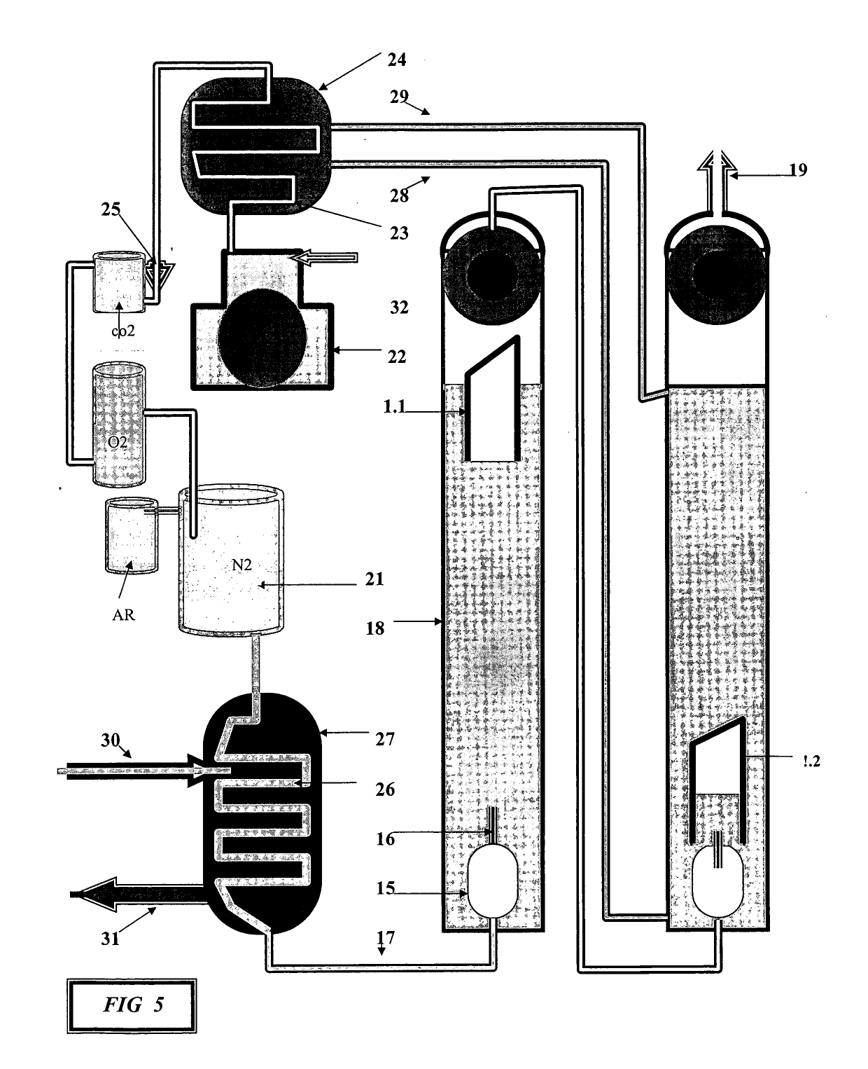

1. An inverted metallic box with a cover closed during the way up and opens to allow down ward movement under its self-weight. The weight of the box is calculated in a way to start its movement directly when half of it is filled with gas. The box is fixed or tied with a chain (10).
2. A joint made of steel, rotating around an axis designed to open and close the cover of box (1).
3. A Bearing with a cover welded or fixed on the top of the cover of box (1) from both sides; the axis of joint (2) is rotating inside it.
4. A metallic cover for box (1) combined from two parts fixed to the joint (2), one of them moves down while the other part moves up exactly in the same time. The cover is covered with rubber or plastic in order to keep the gas inside the box when it is closed.
5. A lock fixed to the side of the box (1) made from steel, it can be calibrated to close the cover (4) of the box (1) tightly. The lower part of this joint can pushed back to allow opening the cover as in (FIG. 1B).
6. Four rollers fixed to the middle of either parts of box (1) guided by two rails in order not to be tilted and make the movement easier.
7. Four joints used to connect the box (1) with the movement transformation chain (10).
8. Metallic frame on which two rails are fixed in front of each other, the rails allow the wheels (6) to slide on them making the movement of the box (1) easier.
9. A gear wheel clutches with its axis rotating in one direction and free moving in the other direction.
10. A metallic chain convolves around gear wheel (9) and its two ends are fixed to the joints (7).
11. Toothed wheel with a size equals to wheel (9), chain (10) convolved around it.
12. Metallic connection on which the axis of the cover (2) is supported. Its calibration closes the cover (4) tightly during which the box (1) will be abut on the base.
13. A hunchbacked metallic connection fixed to a suitable place to move the end of lock (5).
14. An axis made of steel has toothed wheels operates (rotational movement) wheel (9) which operates the electrical generator.
15. A gas tank or container used to collect gas coming from evaporation pipes and expansion valve.
16. A valve made from a steel rod allows the gas to rush out from tank (15) to the box (1).
17. A pipe supplies gas to tank (15).
18. A tank stands the applied pressure in which the frame (8) is positioned. Pipe (17) is welded on it.
19. A pipe from which the gas goes outside tank (18).
20. An anti-freeze liquid (with least possible viscosity and doesn't react with the components of the machine) fills 70% of tank (18).
21. Refrigerant gas doesn't melt in the liquid and doesn't react with the components of the machine.
22. A compressor operates with electrical motor.
23. Compressed gas condensers.
24. Water tank to absorb the heat from condenser (23).
25. Expansion valve after which the gas expands.
26. Pipes in which the cold gas pass through (Cooling line).
27. An insulated tank contains an anti-freeze liquid and the pipes (freezing gas pipes) (26).
28. An outlet pipe for hot water.
29. An inlet pipe for hot water.
30. An inlet pipe for coolant.
31. An outlet pipe for coolant.

1- A method for cooling and production of mechanical energy by allowing the gas flow in a liquid with higher temperature, the heat transfers to the gas to get expanded. The gas replaces the liquid in the container till it starts moving up to the surface of liquid inside the container, then the cover opens and gas rushes out from the box. The box then moves down under the effect of its weight. By this the energy which gas absorb form liquid converts directly to a mechanical energy and then electrical energy; converting the vertical movement of box into rotational movement which operates an electrical generator, or by coiling a copper coil surrounding the path of the moving box, electricity will be generated in the coil because of the aforementioned box movement.

2- Buoyant gas machine produces electricity and cooling and works according to the way mentioned in the first claim, it contains an inverted box designed to move up-ward when half of it filled with gas. If the top cover is open it moves downward. The box is tied with chains surrounding the gear wheel (9), one of them clutch with its axis when the box moves up, and the other one clutches with its axes when the box moves down. On the same axis another two toothed wheels (with bigger diameter) are fixed, those two wheels operate axis (14) which operates a fly wheel and consequently the generator.

3- Electrical generator consists of an insulated copper coil, which is coiled surrounding the path of the vertical moving inverted-box (6), generating electrical current in the coil as a result of the vertical movement of the box. An existing switch (switches direction) of the either movements of the box guarantees the continuity of the electrical current supply.

4- A method to absorb heat from water till it freezes and converts it to electrical energy by allowing the gas to pass through a radiator before the inverted box (6). Production of mechanical energy converted from the energy of the compressed gas and the heat of water.

5- Frozen water and electrical energy plant operates as in claim No. (3), consists of liquid Nitrogen container and a radiator (27) absorbs energy (heat) from the water to be cooled and form which the evaporating gas passes. And also consists of the machine mentioned in claim No. (2) or the electrical generator in claim No. (3)

6- A method for operating a machine using liquid Nitrogen for the production of electrical energy and using them to liquidate other gases.

7- A machine and generator as in the second and third claims produces energy and operates using Nitrogen. Transforms the heat or energy absorbed by Nitrogen through radiator (27) from gas and vapor condensers to electrical energy.

8- A machine and a generator as in the second and third claims operates using Nitrogen and produces electrical energy form solar energy collectors, and transforms heat or energy absorbed by Nitrogen through a radiator from solar energy into electricity.

9- Plant for production of cooling and liquid Oxygen; consists of air liquefaction unit for production of liquid Nitrogen and Oxygen from air. And a machine and a generator as in the second and third claims operating with liquid Nitrogen for the production of cooling and electricity.
